(19) United States
(12) Patent Application Publication
(10) Pub. No.: US 2018/0036682 A1
(43) Pub. Date: Feb. 8, 2018

(54) PURIFICATION OF HIGHLY SALINE FEEDS

(71) Applicant: Surrey Aquatechnology Limited, Guildford, Surrey (GB)

(72) Inventors: Peter George NICOLL, Guildford (GB); Brian James MOORE, Guildford (GB)

(21) Appl. No.: 15/555,066

(22) PCT Filed: Mar. 4, 2016
(86) PCT No.: PCT/GB2016/050586

§ 371 Date: Aug. 31, 2017

(30) Foreign Application Priority Data
Mar. 5, 2015 (GB) 1503728.6

(51) Int. Cl. B01D 61/02; C02F 1/26; B01D 61/12; B01D 61/00; B01D 61/06

(52) U.S. Cl. CPC B01D 61/022; B01D 61/005; B01D 61/06; B01D 61/12; C02F 1/265; B01D 2311/06; B01D 2311/08; B01D 2311/25; B01D 2311/26; B01D 2313/24

(57) ABSTRACT

A process for separating solvent from a feed solution, said process comprising contacting the feed solution with one side of a semi-permeable membrane, applying hydraulic pressure to the feed solution, such that solvent from the feed solution flows through the membrane by reverse osmosis to provide a permeate solution on the permeate-side of the membrane, separating solvent from the permeate solution to provide a stream comprising the solvent and a residual solution having an increased osmotic pressure than the permeate solution, and recycling the residual solution to the permeate-side of the semi-permeable membrane, whereby the osmotic pressure on the permeate-side of the semi-permeable membrane is lower than the osmotic pressure of the feed solution.

The present invention relates to a process for separating a solvent, for example, water from a feed solution. In particular but not exclusively, the present invention relates to a process for the purification of water.

Various methods of water purification and concentration are known. An example of such a method is reverse osmosis. In reverse osmosis, water is forced from a region of high solute concentration through a semipermeable membrane to a region of low solute concentration by applying a hydraulic pressure in excess of the osmotic pressure of the high solute concentration solution. Reverse osmosis is commonly used, for example, to obtain drinking water from seawater. Reverse osmosis is also used to separate water from, for example, industrial waste streams. By using reverse osmosis to treat industrial waste streams, it is possible to generate relatively clean water from industrial waste, while reducing the volume of undesirable waste requiring disposal or further treatment.

Reverse osmosis requires relatively high pressures to be exerted on the high solute concentration side of the membrane. For instance, to desalinate seawater by conventional reverse osmosis techniques, pressures as high as 82 barg are commonly used to increase the recovery of product water. This places a significant energy burden on desalination methods that rely on conventional reverse osmosis. Moreover, streams having higher solute concentrations than seawater may require even higher hydraulic pressures to be applied. Many commercially available reverse osmosis membranes are unsuitable for withstanding hydraulic pressures of greater than 82 barg. Accordingly, this can impose a limitation on the concentration of feed solutions that can be treated using commercially available reverse osmosis membrane, which effectively limits the maximum concentration of the concentrated feed stream to an osmotic pressure equivalent to the maximum hydraulic pressure rating of the reverse osmosis membrane and pressure vessel.

According to the present invention, there is provided a process for separating solvent from a feed solution, said process comprising:
contacting the feed solution with one side of a semi-permeable membrane,
applying hydraulic pressure to the feed solution, such that solvent from the feed solution flows through the membrane by reverse osmosis to provide a permeate solution on the permeate-side of the membrane,
separating solvent from the permeate solution to provide a stream comprising the solvent and a residual solution having an increased osmotic pressure than the permeate solution, and
recycling the residual solution to the permeate-side of the semi-permeable membrane, whereby the osmotic pressure on the permeate-side of the semi-permeable membrane is lower than the osmotic pressure of the feed solution.

The present inventors have found that, by recycling the residual solution to the permeate-side of the semi-permeable membrane, the osmotic pressure difference across the semi-permeable membrane may be reduced. As a result, the hydraulic pressure required to induce solvent flow from the feed solution by reverse osmosis may be reduced. Accordingly, the flux across the semi-permeable membrane is higher compared to that achievable using reverse osmosis alone operating under the same hydraulic pressure limitations. In other words, to achieve the same level of flux across the semi-permeable membrane, lower hydraulic pressures may be employed. An important advantage of the present invention is that it allows highly concentrated feed solutions to be treated at hydraulic pressures that are within the hydraulic pressure ratings of conventional reverse osmosis membranes (e.g. 82 barg or less). With conventional reverse osmosis techniques, such highly concentrated feed solutions would require hydraulic pressures in excess of the maximum hydraulic pressure rating of most conventional reverse osmosis membranes (e.g. above 82 barg).

In one example, the residual solution from the residual-side of the membrane may be withdrawn from the residual-side of the membrane. A portion of the withdrawn solution may be recycled as part of the feed solution to the membrane. This “feed and bleed” arrangement may be used to increase the solute concentration of the feed to the (first) semi-permeable membrane above a minimum threshold and to increase the recovery rate. This can help to ensure a proper flow distribution across the membrane or through the membrane bundle even at high recovery rates.

Solvent may be separated from the permeate solution by any suitable means. Any separation method that can be used to regenerate or concentrate the osmotic agent in the permeate may be employed. For example, thermal methods, such as distillation may be employed. Other suitable examples include phase change, precipitation, degasification and inverse solubility techniques. Such solvent separation methods are well known in the art. In one embodiment, solvent is separated from the permeate solution by contacting the permeate solution with one side of a second semi-permeable membrane, and applying hydraulic pressure to the permeate solution, such that solvent from the permeate solution permeates through the second semi-permeable membrane by reverse osmosis to provide a residual solution having an increased osmotic pressure on the retentate-side of the membrane and a second permeate solution on the permeate-side of the second semi-permeable membrane.

Preferably, the residual solution is recycled from the retentate-side of the second semi-permeable membrane to the permeate-side of first semi-permeable membrane.

In one embodiment, the process further comprises contacting the second permeate solution with one side of a further semi-permeable membrane, applying hydraulic pressure to the second permeate solution, such that solvent from the second permeate solution permeates through the further semi-permeable membrane by reverse osmosis to provide a further residual solution on the retentate-side of the further semi-permeable membrane and a further permeate solution on the permeate-side of the further semi-permeable membrane.

The further residual solution may be recycled from the retentate-side of the further semi-permeable membrane to the permeate-side of first semi-permeable membrane and/or the permeate-side of the second semi-permeable membrane. In one embodiment, prior to contact with said semi-permeable membrane(s), the permeate solution is introduced to a reservoir from which permeate solution may be drawn and contacted with said semi-permeable membrane(s) at a pre-determined rate.

In one example, when the feed solution is contacted with one side of a semi-permeable membrane, the opposite side of the membrane is contacted with a draw solution containing an osmotic agent. The draw solution has an osmotic agent or solute (e.g. salt) concentration that is lower than the osmotic agent or solute (e.g. salt) concentration on the opposite side of the membrane. Accordingly, hydraulic pressure is still required to cause solvent from the feed solution to flow through the membrane by reverse osmosis. However, by raising the osmotic agent or solute concentration on the permeate-side of the membrane, it is possible to initiate the reverse osmosis at a reduced hydraulic pressure.

Prior to being recycled to the permeate-side of said semi-permeable membrane(s), the osmotic pressure of the residual solution(s) may be adjusted. This adjustment may be carried out by adding osmotic agent to the residual solution. For example, an osmotic agent may be added to the permeate-side of the semi-permeable membrane either in solid form or as a feed of osmotic agent solution. Such addition may increase the osmotic pressure of the solution. As a result, the hydraulic pressure required to perform the reverse osmosis step may be reduced.

Suitable osmotic agents include salts, such as sodium chloride. Other examples of salts include salts of ammonium and metals, such as alkali metals (e.g. Li, Na, K) and alkali earth metals (e.g. Mg and Ca). The salts may be fluorides, chlorides, bromides, iodides, sulphates, sulphites, sulphides, carbonates, hydrogencarbonates, nitrates, nitrites, nitrides, phosphates, aluminates, borates, bromates, carbides, chlorides, perchlorates, hypochlorates, chromates, fluorosilicates, fluorosulphates, silicates, cyanides and cyanates. One or more salts may be employed. Where osmotic agent is added to the residual solution, it may be desirable to use osmotic agent that is already present in the residual solution. This may avoid any undesirable interaction between osmotic agent already present in the residual solution and osmotic agent that is added to adjust the osmotic pressure of the residual solution.

Alternatively, a portion of the residual solution may be withdrawn as a bleed. This withdrawal reduces the osmotic pressure of the diluted solution from the permeate side of the semi-permeable membrane.

In one embodiment, prior to being recycled to the permeate-side of said semi-permeable membrane(s), a portion of the residual fluid is discarded or treated to balance the salt passage between the semi-permeable membranes employed in the process, for example, between the first semi-permeable membrane and the second semi-permeable membrane.

In another embodiment, the hydraulic pressure energy within the retenate stream of any of the different semi-permeable membranes that may be employed is recovered by any suitable means. Some examples of suitable methods include the isobaric pressure exchanger and pelton wheel turbine, these and others are illustrated in Energy consumption and recovery in reverse osmosis by Gude (Desalination and Water Treatment, Vol. 36, Iss. 1-3, 2011).

The feed solution may be any solution, such as an aqueous solution. The feed solution may be a salt solution, for example, an aqueous salt solution. In some embodiments, the feed solution is an aqueous solution of sodium chloride. Examples of suitable feed solutions include saline ground water or surface water, brine and seawater. Other examples include waste water streams, lake water, river water and pond water. Examples of waste water streams include industrial or agricultural waste water streams.

The feed solution may be a solution of one or more osmotic agents. Suitable osmotic agents include salts, such as inorganic salts. Suitable salts include salts of ammonium and metals, such as alkali metals (e.g. Li, Na, K) and alkali earth metals (e.g. Mg and Ca). The salts may be fluorides, chlorides, bromides, iodides, sulphates, sulphites, sulphides, carbonates, hydrogencarbonates, nitrates, nitrites, nitrides, phosphates, aluminates, borates, bromates, carbides, chlorides, perchlorates, hypochlorates, chromates, fluorosilicates, fluorosulphates, silicates, cyanides and cyanates. One or more salts may be present.

The total dissolved salt concentration of the feed solution may be at least 5,000 mg/l, for example, 5,000 to 250,000 mg/l. In one example, the total dissolved salt concentration of the feed solution to the semi-permeable membrane is at least 30,000 mg/l. The osmotic pressure of the feed may be at least 4 barg, for example, 4 to 320 barg.

The semi-permeable membrane(s) employed in the present invention may be nanofiltration or reverse osmosis membranes. Preferably, the semi-permeable membrane is a reverse osmosis membrane. Where more than two membranes are employed, the membranes may be the same or different. In one embodiment, the semi-permeable membrane(s) are all reverse osmosis membranes. In another embodiment, the semi-permeable membrane(s) are all nanofiltration membranes. In yet another embodiment, both nanofiltration and reverse osmosis membranes are employed as the semi-permeable membrane(s).

Where employed, the nanofiltration membrane may be selected such that sufficient dissolved salt passes through the nanofiltration membrane, whereby the total dissolved salts concentration or osmotic pressure of the permeate solution on the permeate-side of the nanofiltration membrane is at least 30%, for example, at least 50% or at least 70% of the osmotic pressure of the solution fed to the nanofiltration membrane. For example, the osmotic pressure of the permeate solution on the permeate-side of the nanofiltration membrane is 50 to 90% of the osmotic pressure of the solution fed to the nanofiltration membrane.

The membrane employed in the nanofiltration step (if employed) may have an average (e.g. mean) pore size of 4 to 80 Angstroms. Preferably, the average (e.g. mean) pore size of the membrane is 20 to 70 Angstroms, more preferably 30 to 60 Angstroms, and most preferably 40 to 50 Angstroms. Pore size (e.g. mean pore size) may be measured using any suitable technique. For example, a differential flow method may be employed (Japan Membrane Journal, vol. 29; no. 4; pp. 227-235 (2004)) or the use of salts, uncharged solutes and atomic force microscopy (Journal of Membrane Science 126 (1997) 91-105).

The membranes used in the nanofiltration step (if employed) may be cast as a “skin layer” on top of a support formed, for example, of a microporous polymer sheet. The resulting membrane may have a composite structure (e.g. a thin-film composite structure). Typically, the separation properties of the membrane are controlled by the pore size and electrical charge of the “skin layer”.

Examples of suitable nanofiltration membranes include ESNA-1 (Hydranautics, Oceanside, Calif.), SR 90, NF-270, NF 90, NF 70, NF 50, NF 40, NF 40 HF membranes (Dow FilmTech, Minneapolis, Minn.), TR-60, SU 600 membrane (Toray, Japan) and NRT 7450 and NTR 7250 membranes (Nitto Electric, Japan).

The nanofiltration membrane may be planar or take the form of a tube or hollow fibre. For example, a tubular configuration of hollow fine fibre membranes may be used. If desired, the membrane may be supported on a supporting structure, such as a mesh support. When a planar membrane is employed, the sheet may be rolled such that it defines a spiral in cross-section. When a tubular membrane is employed, one or more tubular membranes may be contained within a housing or shell. The solution may be introduced into the housing, whilst the solvent may be removed as a filtrate from the tubes or vice-versa.

The nanofiltration membrane (if employed) may also be operated at an elevated pressure. For example, the nanofiltration membrane may be operated at a pressure of 25 to 120 bar, preferably 40 to 100 bar, more preferably 50 to 80 bar. As mentioned above, solution from the retentate-side of the second selective membrane is returned to the permeate side of the nanofiltration membrane (if employed).

Any suitable reverse osmosis membrane may be used in the present invention. For example, the reverse osmosis membrane may have an average (e.g. mean) pore size of 0.5 to 80 Angstroms, preferably, 2 to 50 Angstroms. In a preferred embodiment, the membrane has an average (e.g. mean) pore size of from 3 to 30 Angstroms. Pore size (e.g. mean pore size) may be measured using any suitable technique. For example, a differential flow method may be employed (Japan Membrane Journal, vol. 29; no. 4; pp. 227-235 (2004)) or the use of salts, uncharged solutes and atomic force microscopy (Journal of Membrane Science 126 (1997) 91-105).

Suitable reverse osmosis membranes include integral membranes and composite membranes. Specific examples of suitable membranes include membranes formed of cellulose acetate (CA) and/or cellulose triacetate (CTA), such as or similar to those used in the study of McCutcheon et al. Desalination 174 (2005) 1-11 and membranes formed of polyamide (PA). An array of membranes may be employed.

The reverse osmosis membrane may be planar or take the form of a tube or hollow fibre. For example, a tubular configuration of hollow fine fibre membranes may be used. If desired, the membrane may be supported on a supporting structure, such as a mesh support. When a planar membrane is employed, the sheet may be rolled such that it defines a spiral in cross-section. When a tubular membrane is employed, one or more tubular membranes may be contained within a housing or shell.

The reverse osmosis membrane may be carried out at an elevated pressure to drive the (liquid) solution through the membrane. For example, the reverse osmosis step may be carried out at a pressure of 25 to 120 bar, preferably 50 to 100 bar, more preferably 60 to 80 bar.

Optionally, a scale inhibitor, anti-scaling or anti-fouling additive may be added to any one of the solutions in contact with any of the membranes. Preferably, the scale inhibitor, anti-scaling or anti-fouling additive may be re-circulated between the retentate-side of one membrane and a permeate-side of another or vice-versa.

These and other aspects of the present invention will now be described with reference to the accompanying figures, in which:

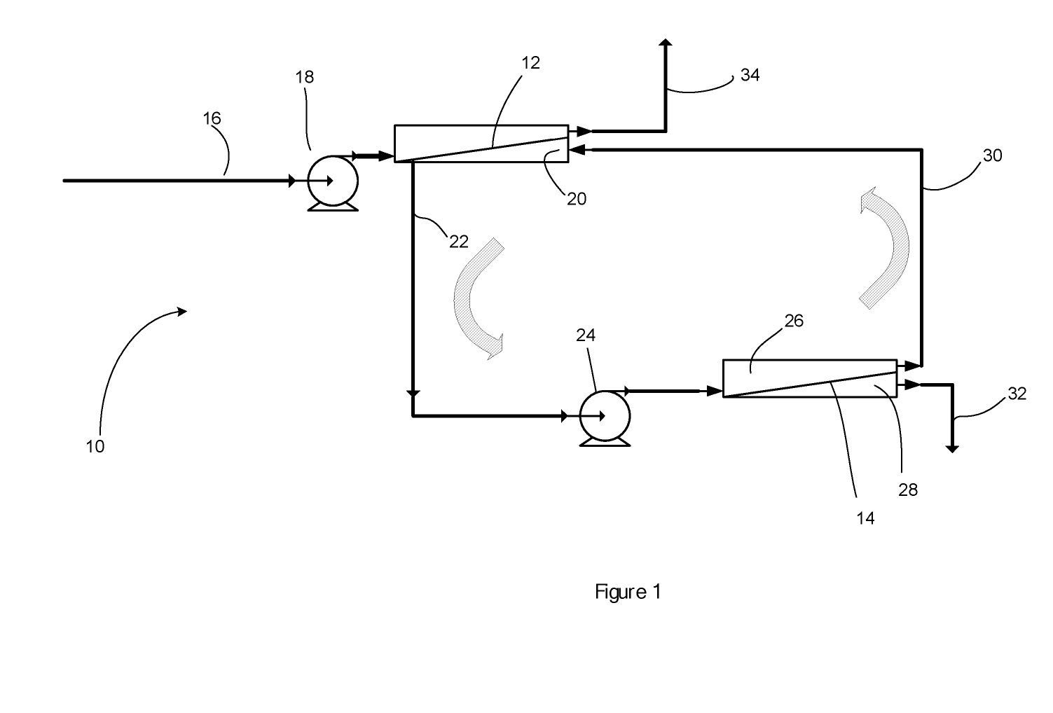

FIG. 1 is a schematic diagram of a system for carrying out a first embodiment of the process of the present invention;

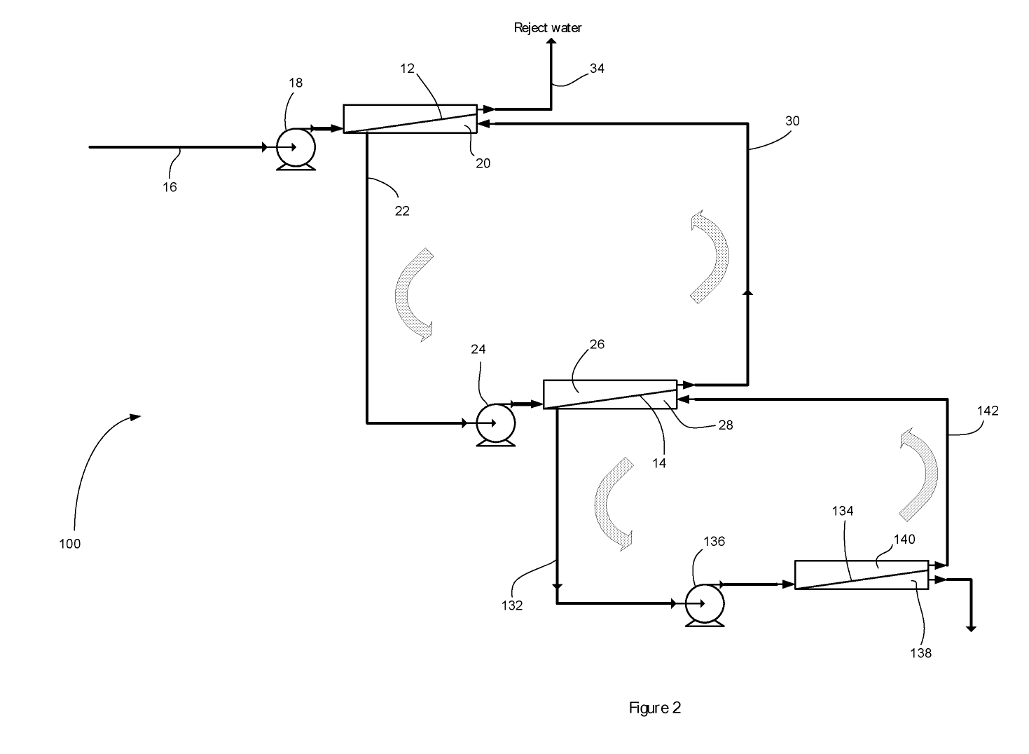

FIG. 2 is a schematic diagram of a system for carrying out a second embodiment of the process of the present invention;

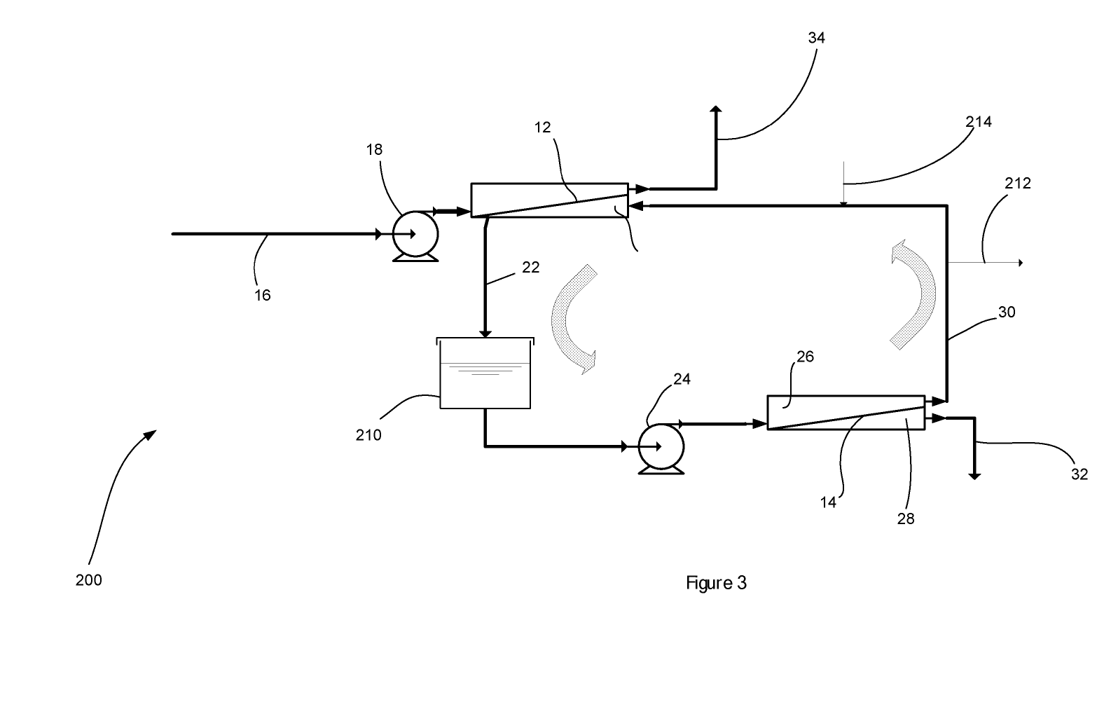

FIG. 3 is schematic diagram of a system for carrying out a third embodiment of the process of the present invention;

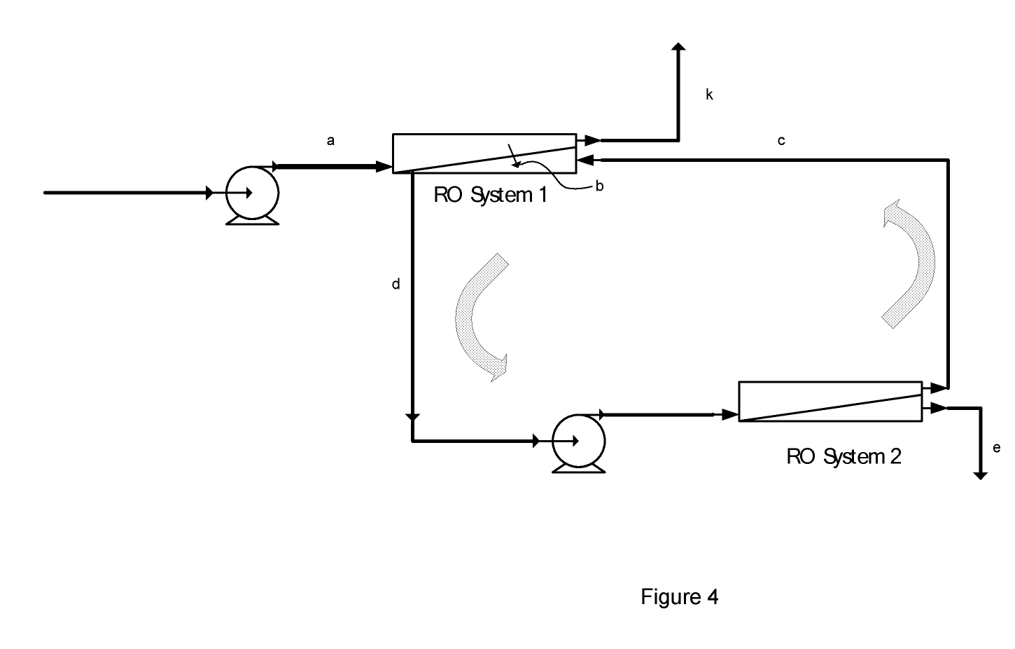

FIG. 4 is identical to FIG. 1 except that the process streams are annotated using the annotations used in Table 1 of the Examples;

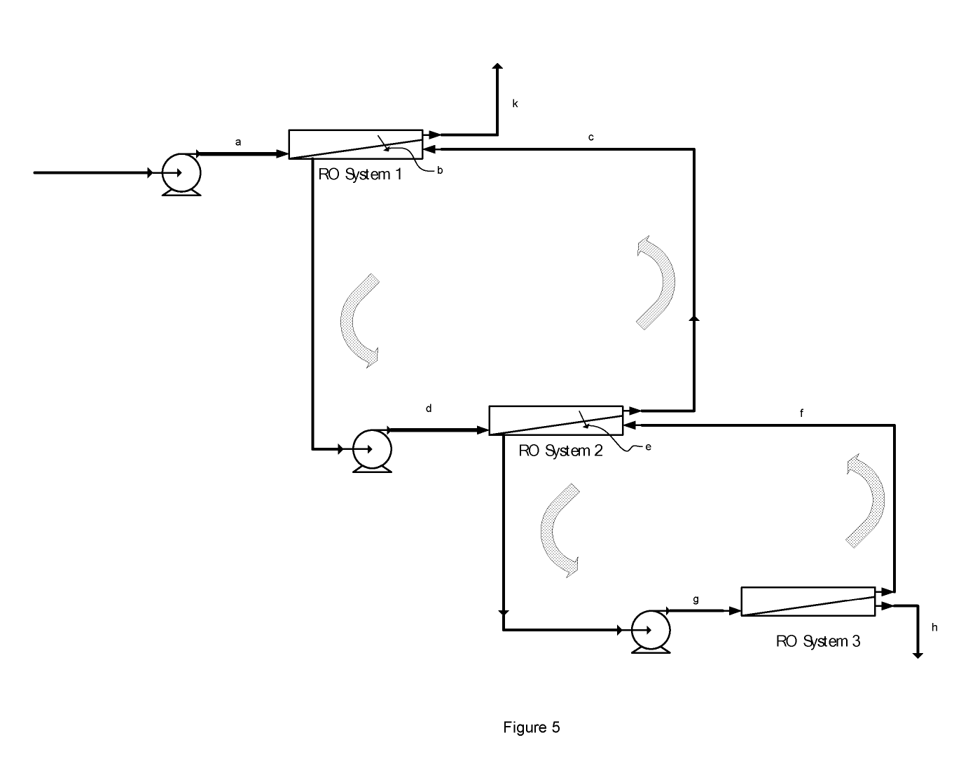

FIG. 5 is identical to FIG. 1 except that the process streams are annotated using the annotations used in Table 1 of the Examples;

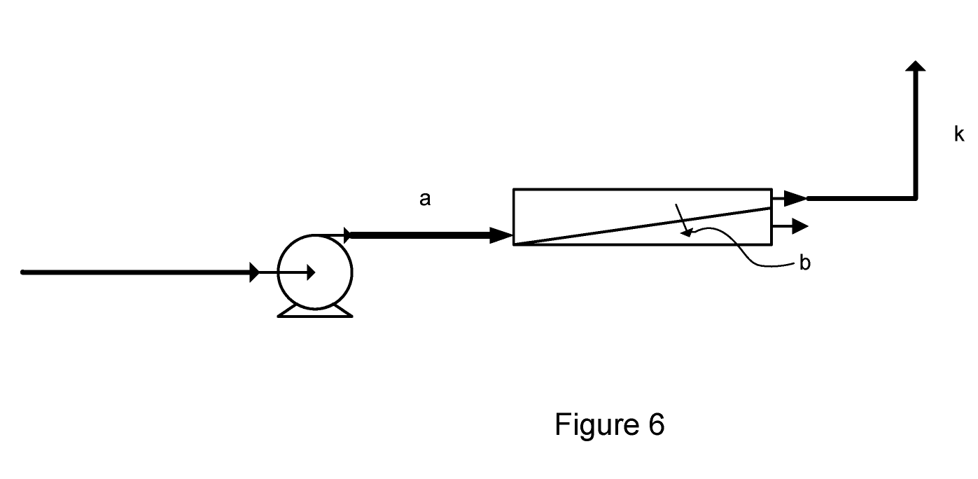

FIG. 6 is a schematic diagram of a system for carrying out the reverse osmosis process of Example 1 showing the annotations used in Table 1 of the Examples; and

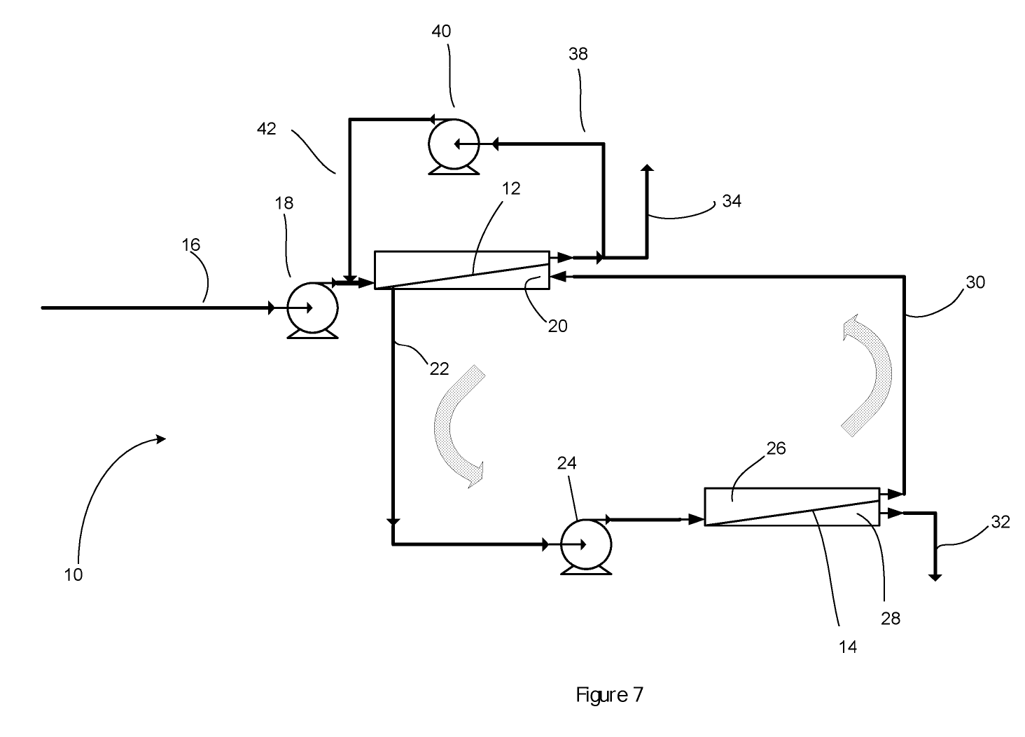

FIG. 7 is a schematic diagram of the process of FIG. 1 with an additional recycle stream.

Referring to FIG. 1, this diagram depicts a system 10 comprising a first reverse osmosis unit comprising a first semi-permeable membrane 12 and a second reverse osmosis unit comprising a second semi-permeable membrane 14.

In operation, feed water 16 is contacted with one side of the first semi-permeable membrane 12. Hydraulic pressure is applied using pump 18, causing water to flow through the first semi-permeable membrane 12 by reverse osmosis. The permeate solution 20 on the permeate-side of the first semi-permeable membrane is withdrawn from the first reverse osmosis unit via line 22 and contacted with one side of the second semi-permeable membrane 14. Hydraulic pressure is applied via pump 24, such that water from the solution permeates through the second semi-permeable membrane 14 by reverse osmosis. This provides a residual solution 26 having an increased osmotic pressure on the retentate-side of the membrane 14 and a second permeate solution 28 on the permeate-side of the second semi-permeable membrane. The residual solution 26 on the retentate-side of the membrane 14 is recycled via line 30 to the permeate-side of the first semi-permeable membrane 12. As the average osmotic pressure on the permeate-side of the first semi-permeable membrane 12 is lower than the average osmotic pressure of the feed water 16 and the reject water 34, hydraulic pressure is still required to induce water to flow across the first semi-permeable membrane 12 by reverse osmosis. However, the average osmotic pressure on the permeate-side of the first semi-permeable membrane 12 is higher than what it would be in the absence of the recycle via line 30. Accordingly, the hydraulic pressure required to be applied to the feed water 16 to maintain a predetermined flux across the semi-permeable membrane 12 is less than that which would be required in the absence of the recycle via line 30.

The permeate 28 through the second semi-permeable membrane 14 may be withdrawn as product water 32, while the retentate on the retentate-side of the first semi-permeable membrane 12 may be withdrawn as reject water 34. Optionally, a portion of the reject water 34 may be recycled as feed to the membrane 12 (not shown), for example, by pump 18. This can increase the concentration of the feed water that is contacted with the membrane 12 e.g. above a threshold value and increase the recovery rate. This can improve flow distribution across membrane 12. Optionally, as shown in FIG. 7, a portion 38 of the reject water 34 may be recycled by pump 40 as a portion 42 of the feed to membrane 12. This can increase the concentration of the feed water that is contacted with the membrane 12 e.g. above a threshold value and increase the recovery rate. This can improve flow distribution across membrane 12.

The embodiment of FIG. 2 depicts a system 100 that is similar to that of FIG. 1. Like numerals have been used to label like parts. In the system 100 of FIG. 2, however, the permeate 28 through the second semi-permeable membrane 14 is withdrawn via line 132 and this is contacted with a third semi-permeable membrane 134. Hydraulic pressure is applied to the permeate via pump 136 such that water flows across the membrane 134 by reverse osmosis. The permeate 138 through the third semi-permeable membrane 134 is withdrawn as product water, while the retentate 140 on the retentate-side of the third semi-permeable membrane 134 is recycled via line 142 to the permeate-side of the second semi-permeable membrane 14. As the average osmotic pressure on the permeate-side of the second semi-permeable membrane 14 is lower than the average osmotic pressure on the retentate-side of the membrane 14, hydraulic pressure is still required to induce water to flow across the semi semi-permeable membrane 12 by reverse osmosis. However, the average osmotic pressure on the permeate-side of the second semi-permeable membrane 14 is higher than what it would be in the absence of the recycle via line 142. Accordingly, the hydraulic pressure required to be applied to the permeate from the first semi-permeable membrane in line 22 to maintain a predetermined flux across the semi-permeable membrane 14 is less than that which would be required in the absence of the recycle via line 142.

The embodiment of FIG. 3 depicts a system 200 that is similar to that of FIG. 1. Like numerals have been used to label like parts. In the embodiment of FIG. 3, however, the permeate 20 from the first semi-permeable membrane is introduced via line 22 to a reservoir 210 from which solution may be drawn and contacted with the second semi-permeable membrane 14 at a pre-determined rate. Furthermore, lines 212 and/or 214 may be provided to withdraw a portion of the residual solution 26 (e.g. as bleed) or to treat the residual solution to balance the salt passage between the first semi-permeable membrane 12 and the second semi-permeable membrane 14. The addition of osmotic agent 214 allows the start-up of the process in particular where the osmotic pressure of the feed solution 16 is greater than the maximum hydraulic pressure that can be applied to the semi-permeable membrane 12, by lowering the differential osmotic pressure between the feed solution 12 and the permeate solution 22.

### EXAMPLES

In the following non-limiting Examples, we consider three processes for the desalination of a feed water stream consisting of a sodium chloride solution using reverse osmosis. The maximum hydraulic pressure that can be applied to the reverse osmosis membrane is 69 barg (Dow Filmtec membrane SW30HR-380). The process parameters are summarised in Table 1, with all values being approximate.

Example 1 considers the situation where the feed water has a concentration of sodium chloride of 80,000 mg/l. This solution is contacted with a reverse osmosis membrane and a hydraulic pressure of 69 barg is applied (i.e. the maximum hydraulic pressure that the reverse osmosis membrane can withstand). The process scheme for this reverse osmosis process is shown in FIG. 6. Because the feed water has a calculated value of osmotic pressure of 70.7 bar at 25 degrees Celsius, there is no solvent flow. This is tabulated in Table 1 below.

Example 2 is an example of an embodiment of the invention operated in accordance with the system depicted in and described with reference to FIG. 1. FIG. 4 is identical to FIG. 1 except that the process streams are annotated using the annotations used in Table 1 below. The feed water composition is the same as that used in Example 1. The results are tabulated in Table 1 below. As can be seen from the Table, desalination can be achieved despite the feed pressure to RO1 being less than the osmotic pressure of the feed water stream. In this case, stream d, may be initially prepared by the addition of a sodium chloride solution with a TDS of 36096 mg/l.

Example 3 illustrates a second embodiment of the invention operated in accordance with the system depicted in and described with reference to FIG. 2. FIG. 5 is identical to FIG. 2 except that the process streams are annotated using the annotations used in Table 1 below. In this case the feed solution has a concentration of sodium chloride of 120,000 mg/l, with an equivalent osmotic pressure of 116 bar at 25 degrees Celsius. In this case two steps are used to produce the solvent and/or concentrate the initial feed stream. In this case, stream d, may be initially prepared by the addition of a sodium chloride solution with a TDS of 68184 mg/l and stream g may be initially optionally prepared by the addition of a sodium chloride solution with a TDS of 15786 mg/l.

TABLE 1

| | | Example No. | | |
|---|---|---|---|---|
| | | 1 | 2 | 3 |
| | | FIG. No. | | |
| | | 6 | 4 | 5 |
| | | | Example | Example |
| | | | of the | of the |
| | | A single | invention | invention |
| | | reverse | using two | using three |
| | | osmosis | stages as | stages as |
| | | membrane | shown in | shown in |
| | | only. | FIGS. 1 | FIGS. 2 |
| | | Osmotic | and 4. All | and 5. All |
| | | pressure of | RO feed | RO feed |
| | | feed solution | pressures | pressures |
| | | greater than | below the | below the |
| | | maximum | maximum | maximum |
| | | hydraulic | set for this | set for this |
| | | pressure- | example at | example at |
| | Stream | hence no | 69 barg | 69 barg |
| Description | No | solvent flow | (FIG. 4) | (FIG. 5) |
| Feed TDS as NaCl (mg/l) | a | 80000 | 80000 | 120000 |
| Osmotic Pressure (bar) | a | 70.7 | 70.7 | 116 |
| at 25° C. | | | | |
| Feed flow (m3/h) | a | 100 | 100 | 100 |
| Feed pressure to RO1 | a | 69 | 69 | 69 |
| (barg) | | | | |
| Solvent flow from RO1 | b | 0 | 40 | 23.3 |
| (m3/h) | | | | |
| Retentate flow from RO1 | k | 100 | 60 | 76.7 |
| (m3/h) | | | | |
| Retentate TDS as NaCl | k | 80000 | 133413 | 156516 |
| (mg/l) from RO1 | | | | |
| Retenate osmotic | k | 70.7 | 133.3 | 166.3 |
| pressure (bar) from RO1 | | | | |
| RO1 Concentrated | c | Not | 65000 | 100000 |
| Osmotic Agent TDS as | | applicable | | |
| NaCl (mg/l) | | | | |
| RO1 Concentrated | c | Not | 50 | 50 |
| osmotic agent flow | | applicable | | |
| (m3/h) | | | | |
| RO1 Dilute osmotic | d | Not | 90 | 73.3 |
| agent flow (m3/h) | | applicable | | |
| RO1 Dilute osmotic | d | Not | 36096 | 68184 |
| agent TDS (mg/l) | | applicable | | |
| Feed pressure to RO2 | d | Not | 58 | 62.2 |
| (barg) | | applicable | | |
| Solvent flow from RO2 | e | Not | 40 | 23.3 |
| (m3/h) | | applicable | | |
| RO2 Concentrated | f | Not | Not | 25000 |
| Osmotic Agent TDS as | | applicable | applicable | |
| NaCl (mg/l) | | | | |
| RO2 Concentrated | f | Not | Not | 40 |
| osmotic agent flow | | applicable | applicable | |
| (m3/h) | | | | |
| RO2 Dilute osmotic | g | Not | Not | 63.3 |
| agent flow (m3/h) | | applicable | applicable | |
| RO2 Dilute osmotic | g | Not | Not | 15786 |
| agent TDS (mg/l) | | applicable | applicable | |
| Feed pressure to RO3 | g | Not | Not | 18 |
| (barg) | | applicable | applicable | |
| Solvent flow from RO3 | h | Not | Not | 23.3 |
| (m3/h) | | applicable | applicable | |
| Overall system recovery | | 0% | 40% | 23.30% |
| (Net solvent out/Feed | | | | |
| flow in) | | | | |

1. A process for separating solvent from a feed solution, said process comprising:
contacting the feed solution with one side of a semi-permeable membrane,
applying hydraulic pressure to the feed solution, such that solvent from the feed solution flows through the membrane by reverse osmosis to provide a permeate solution on the permeate-side of the membrane,
separating solvent from the permeate solution to provide a stream comprising the solvent and a residual solution having an increased osmotic pressure than the permeate solution, and
recycling the residual solution to the permeate-side of the semi-permeable membrane, whereby the osmotic pressure on the permeate-side of the semi-permeable membrane is lower than the osmotic pressure of the feed solution.

2. The process as claimed in claim 1, wherein the residual solution from the residual-side of the membrane is withdrawn from the residual-side of the membrane, and wherein a portion of the withdrawn solution is recycled as part of the feed solution to the membrane.

3. The process as claimed in claim 1, wherein solvent is separated from the permeate solution by:
contacting the permeate solution with one side of a second semi-permeable membrane, and
applying hydraulic pressure to the permeate solution, such that solvent from the permeate solution permeates through the second semi-permeable membrane by reverse osmosis to provide a residual solution having an increased osmotic pressure on the retentate-side of the second semi-permeable membrane and a second permeate solution on the permeate-side of the second semi-permeable membrane.

4. The process as claimed in claim 3, wherein the residual solution is recycled from the retentate-side of the second semi-permeable membrane to the permeate-side of first semi-permeable membrane.

5. The process as claimed in claim 3, which further comprises contacting the second permeate solution with one side of a further semi-permeable membrane, and
applying hydraulic pressure to the second permeate solution, such that solvent from the second permeate solution permeates through the further semi-permeable membrane by reverse osmosis to provide a further residual solution on the retentate-side of the further semi-permeable membrane and a further permeate solution on the permeate-side of the further semi-permeable membrane.

6. The process as claimed in claim 5, wherein the further residual solution is recycled from the retentate-side of the further semi-permeable membrane to the permeate-side of first semi-permeable membrane and/or the permeate-side of the second semi-permeable membrane.

7. The process as claimed in claim 1, wherein, prior to contact with said semi-permeable membrane(s), the permeate solution is introduced into a reservoir from which permeate solution may be drawn and contacted with said semi-permeable membrane(s) at a pre-determined rate.

8. The process as claimed in claim 1, wherein, prior to being recycled to the permeate-side of said semi-permeable membrane(s), the osmotic pressure of the residual solution(s) is adjusted.

9. The process as claimed in claim 1, wherein the hydraulic energy on the retentate side of any of the semi-permeable membranes employed is recovered.

10. The process as claimed in claim 8, wherein said adjustment occurs by the addition of osmotic agent to the residual solution.

11. The process as claimed in claim 10, wherein the osmotic agent is selected from a salt.

12. The process as claimed in claim 1, wherein, prior to being recycled to the permeate-side of said semi-permeable membrane(s), a portion of the residual fluid is discarded or treated to balance the salt passage between the first membrane and the second membrane.

13. The process as claimed in claim 1, wherein the osmotic pressure of the feed solution is in excess of 30 bar at 25 degrees C.

14. The process as claimed in claim 1, wherein the osmotic pressure difference across the semi-permeable membrane(s) is within 5 to 70 bar.

15. The process as claimed in claim 1, wherein the feed solution is a salt solution.

16. The process as claimed in claim 1, wherein the semi-permeable membrane(s) are reverse osmosis membranes or nanofiltration membranes.

17. The process as claimed in claim 1, wherein a feed comprising solid osmotic agent or a feed solution comprising osmotic agent is added to the permeate-side of at least one of the semi-permeable membranes.

18. The process as claimed in claim 17, wherein a feed solution comprising osmotic agent is contacted with the permeate-side of the semi-permeable membrane as a draw solution to initiate the reverse osmosis step.

19. The process as claimed in claim 17, wherein the feed solution comprising osmotic agent is formed by dissolving an osmotic agent in water.

20. The process as claimed in claim 1 wherein solvent is separated from the permeate solution by using any thermal separation method and to provide a residual solution having an increased osmotic pressure to be recycled to the permeate side of the first semi-permeable membrane.
